(19) United States
(12) Patent Application Publication
(10) Pub. No.: US 2005/0237622 A1
(43) Pub. Date: Oct. 27, 2005

(54) Color 3D image display

(76) Inventor: Kazutora Yoshino, Eden Prairie, MN (US)

Correspondence Address: KAZUTORA YOSHINO, 7227 Divinity Ln., Eden Prairie, MN, 55346, US

(21) Appl. No.: 11/156,323

(22) Filed: Jun. 20, 2005

Related U.S. Application Data
(62) Division of application No. 10/628,541, filed on Jul. 28, 2003, now abandoned.

(51) Int. Cl. G02B 27/10

(52) U.S. Cl. 359/618

(57) ABSTRACT

Color 3D image display devices that show realistic 3D images using the virtual light points fields. Color-intensity and directions of the virtual light points fields are controlled by various methods such as selection of directions of properly color-intensified light rays. For such methods, micro-pinholes, liquid crystal pinholes, varifocal micro-lens arrays and varifocal index-gradient lens, etc. are used together with high-resolution and high-speed 2 dimensional pattern-generating displays. By adding linear (reciprocating) and/or rotational motion to such 3D display makes higher resolution and view angles wider.

### CROSS REFERENCE TO RELATED APPLICATIONS:

This is a division of Ser. application No. 10/628,541 filed at Jul. 28, 2003.

### FEDERALLY SPONSORED RESEARCH

Not Applicable

### SEQUENCE LISTING OR PROGRAM

### BACKGROUND OF INVENTION

1. Background—Field of Invention

This invention relates to the image display devices such as 3DTV, hologram, stereo display device, volumetric display device that are used for displaying the 3 dimensional object or images.

2. Background—Description of Prior Art

In the conventional way, it was difficult to display the 3 dimensional object or images in real time (run time) by viewed by the multiple users without special glasses in the space only by light. So devices such as TV are showing the converted 2 dimensional images from the 3 dimensional objects.

There are some 3 dimensional displays available.

The virtual headsets are showing the two different images to each eye of users by screens to create the 3 dimensional images. The shutter glasses can also show 3D images having fast changing alternating left and right images. But many people feel uncomfortable wearing such devices and some gets cyber sick easily.

The holograms are showing 3 dimensional images, but these images are difficult to be changed in real time (run time).

The conventional method to project the 2 dimensional image to rotating plate, spiral screen, reciprocating screen to create 3 dimensional image shows only the surface shape of images and they don't show realistic 3 dimensional image. (Actuality, Felix, Act Research) The conventional method to project the 2 dimensional images to plurality of semi-transparent plates to create 3 dimensional images are very expensive because multiple DMD, GLV costs a lot. U.S. Pat. No. 5,394,202 (Deering, 1995) and U.S. Pat. No. 5,907,312, (Sato, et al., 1999) release some of these methods.

In Japanese Patent No. 288957 or HO1-193836 (Felix Gashia, et al, 1989) shows the way to make 3 dimensional image by project the 2 dimensional image to rotating plate. This put red, blue, green laser beam together to light fiber, and run the light to make the 2 dimensional image on the angled and rotated plate so that it would show the 3 dimensional image as a result. But, this one is rotating fast enough to be able to hurt users. And therefore, it is not suitable for user to touch the 3 dimensional image created by this device. Also, this by itself is almost impossible to show the image in the space only by light.

In U.S. Pat. No 3,647,284 (Virgil B Ethlgs, et al.,1972) show the method of showing 3 dimensional image made by the light that was originally scattered by an object. This device put two dish means facing each other. The top dish means has ring shape, that is it has a hole in the middle, and 3 dimensional image shows up over this hole when user put the object at the bottom of the bottom dish means. Each of dishes has reflecting material inside to reflect lights. But this device by itself would be unsuitable to show the real time (run time) 3 dimensional image because it is composed of two dishes.

SHARP, INC. and 3DT, INC. has developed the 2-eye method 3 dimensional displays for a flat panel. Users can see from one angle and cannot locate themselves anywhere to look at the 3D image.

SANYO, INC. has developed the 3 dimensional displays using pinholes. But in their method, it is not easy to make flat panel because it need extra-bright light source behind. Also, it is difficult to apply current technology to manufactures. It tends to be expensive. Also, the data conversion from 3 D object to 2D liquid crystal takes too long time to be for run time application. And their resolution is low.

### OBJECTS AND ADVANTAGES

This invention has advantages relative to prior art in

1 .This device of invention can display true realistic 3D image as if it is there.

2.Multi users can view the 3D images

3.It could show both 2D and 3D images.

4.It can be manufactured easily using current 2D display technology

5. The conversion time is small.

### SUMMARY

The device of invention can display 3 dimensional images by generating the virtual light distribution. Suppose incoming light is projected to a point of surface of object. If the normal vector on the point of the surface is having the angle of theta to the incoming light vector, the maximum reflection occurs to the angle of theta from the normal vector in symmetry. The diffusion occurs depend of the surface of material. It usually has Gauss distribution (approximately with the color-intensity of Amax*(Cos alpha)\hat{ }2 where Amax is the color-intensity of the theta reflection) (FIG. 1-2-1). By having the superposition of incoming and reflecting light vectors to each point on surfaces, the surfaces of 3D object create vector field of lights. Now, if we can create the vector field of lights, especially for the reflecting lights, one can perceive it as if there is the 3D object (FIG. 1-2-2). Also, it can even created the surface behind another object (FIG. 1-2-3). There are many ways to make this kind of vector distribution of lights. One of simplest ways is to make the panel, hemisphere, sphere, or curved surface panels from which the directed light is projected (FIG. 1-2-4 to FIG. 1-2-10). This can be done in various ways as well. There are many ways to direct lights. The pinholes are put in front of 2-D images to create virtual light point (FIG. 2-1-1, FIG. 2-1-2). This can be moved linearly and/or rotationally to be located to proper location of 3D image surface. Also, selected/displayed light rays are coming out of pinhole lenses, micro-lenses to make virtual light points (FIG. 2-4-3, FIG. 2-4-2). Focus of these rays becomes the virtual light points. And by distributing these virtual light points, 3D images can be generated. One is to make all direction light sources and select the necessary lights using masks in controllable (or run-time) pattern (FIG. 2-5-1). Or also, having micro-mirrors that can be controlled in proper angles to reflect incoming light, it can generate the vector field of light (FIG. 2-6-1). Also, the directed light by reflection with motion of reflector can create such vector field as well (FIG. 2-7-1). Also, the mechanical motion can be added to 3D image display in order to increase the resolution, etc. (FIG. 2-8-1, FIG. 2-9-1).

To make all direction light sources and select the necessary lights using masks in controllable (or run-time) pattern (FIG. 2-5-1), one can select special pinhole lens 2-dimensional arrays and high-resolution 2-dimensional image display (FIG. 3-1-1). By having the pinholes on the top of the 2-dimensional image display, it would reduce the cost of products, and thereby it has advantage as invention. Example mapping is that given a virtual point P(Xp, Yp, Zp), the points Qij(Xq,Yq) on 2-dimensional display are described in
Xq=(1+(k/Zp))*(i)−(k/Zp)*(Xp)
Yq=(1+(k/Zp))*(j)−(k/Zp)*(Yp)

Where k is the distance between the pinholes and 2-D display. The intension of each point on display varies depending of the angles of vector field at virtual point P.

By superposing the vector fields on each point of 3D image surface, it generates the virtual 3 dimensional images. It can change the 2D image in proper timing to create living (animating) 3D images (FIG. 3-1-2).

The pinhole and 2D image display can be flipped if 2D display is like liquid crystal (FIG. 3-2-1, FIG. 3-2-2).

One may like to have more resolution than the fixed pinhole arrays. One method is to create the timely created pinhole lens arrays using fast response 2-dimensional pattern generator (FIG. 3-3-1 to 3-4-2). Liquid crystal such as nematic or ferroelectric liquid crystal can be used for the 2D pattern generator. Liquid crystals on glass plate may be achieved to make these patterns. One layer can be used to make pinholes that change the locations in fast time for the purpose of the higher resolution. Optionally, mask layer that also change the pattern in fast time can be inserted (to make 1 to 1 correspond). In this case the 2-D display needs to be fast response as well. (fliquid crystal display Nematic/Ferroelectric/liquid crystal with continuous grain silicon (tft)) Liquid crystal displays, Plasma display, (Organic/Inorganic) Electro-luminescent display (O.E.L.), CRT, micro-laser arrays etc. can be used for the 2-D displays.

3D displays can be moved linearly and/or rotationally to increase the resolution, reality, etc. (FIG. 3-5-1 to FIG. 3-5-5).

Micro-lens arrays and 2D display can be combined to generate 3 dimensional images (FIG. 4-1-1 to FIG. 4-1-4). Selected light patterns get into micro-lens arrays to be directed to proper direction. The field of light source could be parallel field, conservative field, and non-conservative field. It can be projected from diode panel light source, arc lamp, laser, etc.

By having fast oscillation of the depth of 2-D images can create 3-D images.

One way is that the varifocal micro-lens array can be used with 2 dimensional displays. Varifocal micro-lens arrays such as electro-optic micro-lens arrays is put together to liquid crystal such as ferro-electric liquid crystals to give the fast various height of 2 dimensional images to produce 3 dimensional images (FIG. 4-2-1, FIG. 4-2-2).

Also, the micro-array lens can be moved linearly and/or rotationally to increase the resolution, reality, etc. (FIG. 4-2-4, FIG. 4-2-5)

Micro-lens arrays with fast response varifocal lens can be put together for creating the depth of 2D images therefore 3D images as whole (FIG. 4-3-1 to 4-3-3). The trick is how to make such fast response and accurate varifocal lens.

By creating different index of refraction using layer materials such as liquid crystals that can be controlled electrically, it can generated controlled index-gradient lens that can vary the focal length depending on the index of refraction (FIG. 4-4-1)

This can be used directly (FIG. 4-4-2) or with multi-layers of liquid crystals as screens to get the projected images of 2-D display (FIG. 4-3-3).

Also, micro-lens arrays, index-gradient lens and 2-D display can be put together to select and direct the light vector field (FIG. 5-1-1 to FIG. 5-1-3).

Also, micro-lens arrays and 2-D display with proper optics can be put together to select and direct the light vector field (FIG. 5-1-4).

The detailed light-path of each unit are shown in FIG. 5-2-1 to FIG. 5-2-5.

Varifocal electro-optic micro-lens arrays can be made with the shapes of micro-lens with electro-optic materials such as liquid crystals with polarizing plate.

Varifocal pinhole lens can be made of liquid crystals that can have various pinhole-diameter to change the focus length of pinhole lens together with polarizing plate. Varifocal index-gradient lens can be made layers of liquid crystals with different index of refraction that can be controlled by the electrical field together with polarizing plate.

### DRAWINGS

Drawing Figures

FIG. 1-1-1 through FIG. 1-1-9 shows the example diagrams of 3D display from side view.

FIG. 1-2-1 through FIG. 2-4-2 shows the example diagrams of concept how to make 3D images.

FIG. 2-5-1 through FIG. 2-9-1 shows the example diagrams of general pictures of 3D image displays.

FIG. 3-1-1 through FIG. 3-4-2 shows the example diagrams of devices with pinhole lens arrays with high-resolution 2D display style 3D image display

FIG. 3-5-1 through FIG. 3-5-5 shows the example diagrams of devices with pinhole lens arrays with high-resolution & high-speed 2D display style 3D image display with different shapes and/or with motion.

FIG. 4-1-1 through FIG. 4-1-4 shows the example diagrams of devices with micro-lens arrays and high-resolution 2D display.

FIG. 4-2-1 through FIG. 4-2-1 shows the example diagrams of devices with varifocal micro-lens arrays with high-speed 2D display.

FIG. 4-2-3 through FIG. 4-2-5 shows the example diagrams of devices with micro-lens arrays with high-speed & high-resolution 2D display with motion.

FIG. 4-3-1 through FIG. 4-3-2 shows the example diagrams of devices with micro-lens arrays with varifocal lens means with high-speed 2D display.

FIG. 4-3-3 shows the example diagrams of devices with varifocal lens (like electro-optic index-gradient varifocal lens, liquid crystal varifocal lens, etc.) with high-speed 2D display.

FIG. 4-4-1 through FIG. 4-4-2 shows the example detailed diagrams of devices with micro-lens arrays with varifocal lens means with high-speed 2D display.

FIG. 4-4-3 shows the example diagrams of devices with micro-lens arrays with varifocal lens means with multi-layer liquid crystals with high-speed 2D display.

FIG. 5-1-1 through FIG. 5-1-3 shows the example diagrams of devices with micro-lens arrays with index-gradient lens with high-resolution 2D display.

FIG. 5-1-4 shows the example diagrams of devices with micro-lens arrays with high-resolution 2D display.

FIG. 5-2-1 through FIG. 5-2-5 shows the example detailed diagrams of elementary unit of 3D displays.

### REFERENCE NUMERALS IN DRAWINGS

(1) Virtual Lights Field
such as 3 dimensional light vector field, parallel beam field, conservative light vector field, non-conservative light vector field, distributed virtual light points, virtual light point(s), scanned virtual light field(s)

(10) Varifocal Fens Means
such as varifocal lens, electro-optic micro-lens arrays, varifocal pinhole lens, varifocal index-gradient lens, varifocal liquid crystal lens, piezo-electric lens, acousto-optic micro-lens arrays, varifocal liquid crystal Fresnel lens

(20) 2 Dimensional Image Display Means
such as liquid crystal display, ferroelectric liquid crystal, nematic liquid crystal, liquid crystal panel with polarizing plates, micro-liquid crystals arrays, micro-liquid crystals arrays with polarizing plates, ferroelectric micro-liquid crystals arrays with polarizing plates, plasma display, organic electro-luminescent display, laser arrays, micro-laser arrays, diode laser arrays, nano-2D pattern generator (light diffraction generator), CRT

(30) Light Source Means
such as light source, uniform diode light emitter, arc lamp with optics, light fibers with light source, lasers, lasers with optics, parallel beam generator, light conservative vector field generator, light source with polarizing plate(s), polarized light source.

(40) Micro-Lens Arrays Means
such as pinhole lens arrays, micro-pinhole lens arrays, micro-lens arrays, index-gradient lens arrays, liquid crystal pinhole lens arrays, electrooptic micro-lens arrays, nematic/ferreoelectric liquid crystals arrays, liquid crystal panel with polarizing plate, 2 dimensional image pattern maker, (varifocal micro-lens arrays)

(50) Screen Means
such as fast phase-changeable panel, liquid crystal panels, liquid crystal panels with polarizing plates, ferroelectric liquid crystal panels, ferroelectric liquid crystal panels with polarizing plates, micro-lens arrays, pinhole lens arrays, moving screen, moving micro-lens arrays, moving pinhole lens arrays

(70) Micro-Lens Means
such as pinhole lens, pinhole lens arrays, micro-lens, micro-lens arrays, liquid crystal pinhole lens (arrays), electro-optic micro-lens (arrays), liquid crystal, nematic/ferreoelectric liquid crystals, liquid crystal panel with polarizing plate, 2 dimensional image pattern maker, varifocal micro-lens (arrays), index-gradient lens (arrays)

(80) Mask Means
such as mask(s), 2 dimensional image pattern maker, liquid crystal, nematic/ferreoelectric liquid crystals, liquid crystals with polarzing plate

(90) Optical Component Means
such as lens, varifocal lens, plate, mirror, optical instruments

(100) High Speed 2 Dimensional Image Projector

(110) Electrode Means

(120) Index of Refraction Modifier Means
such as liquid crystal (panel), glass

(150) Special Lens Means
such as index-gradient lens, parallel beam generator

(170) Elementary Display Unit Means
such as the elementary units of display

(201) Data Handler Means
such as data, signal data, signal information handler, image data

(202) Controller Means
such as PID, PWM, neural controller

(203) Information Input and/or Output Unit Such As Antenna, Electrode, Channel, Signal/Information Emitter, Signal/Information Receiver

(204) Information Input and/or Output Unit Such As Antenna, Electrode, Channel, Signal/Information/Wave Emitter, Signal/Information/Wave Receiver

(205) Controller

(206) Image Handling Unit, Wave Emitter, Wave Receiver, Light Emitter, Light Receiver

### DETAILED DESCRIPTION

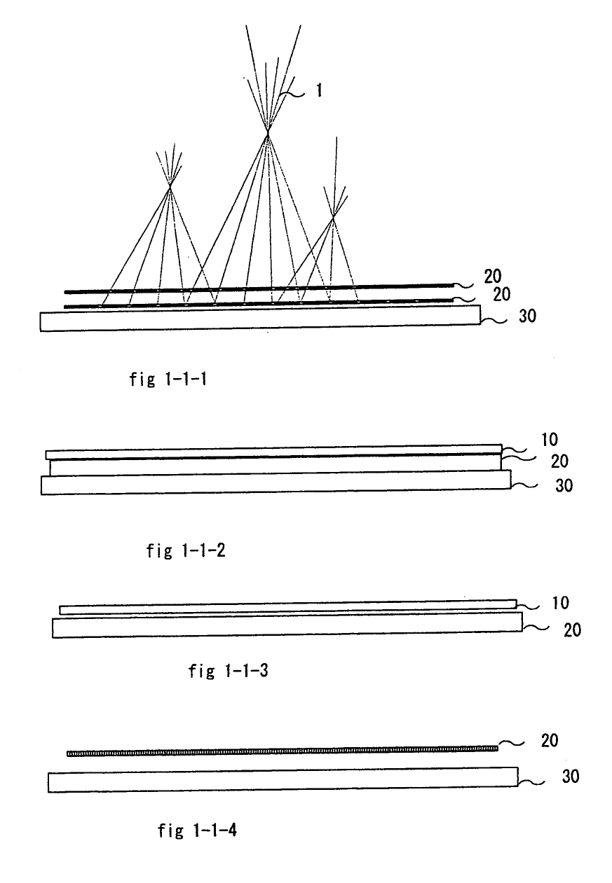

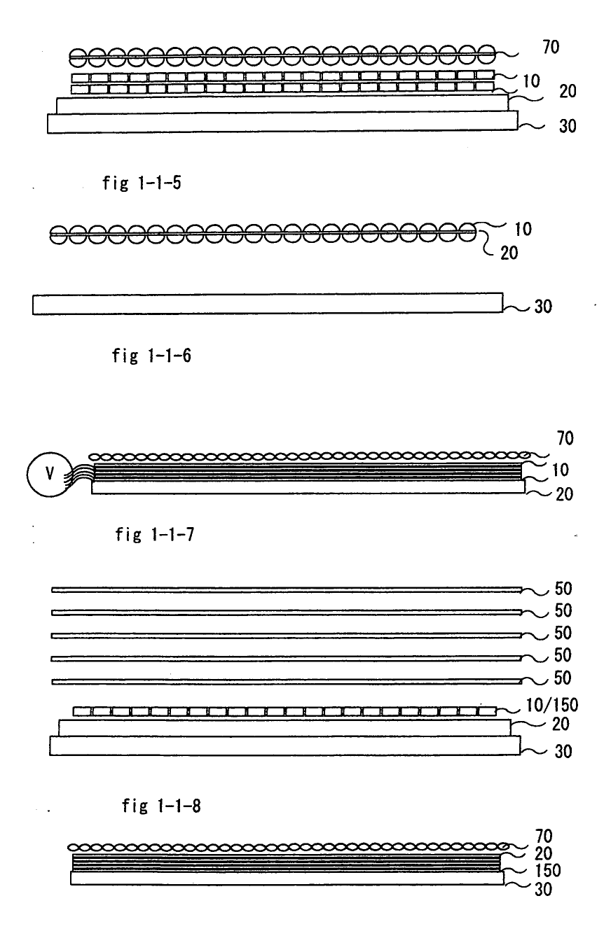

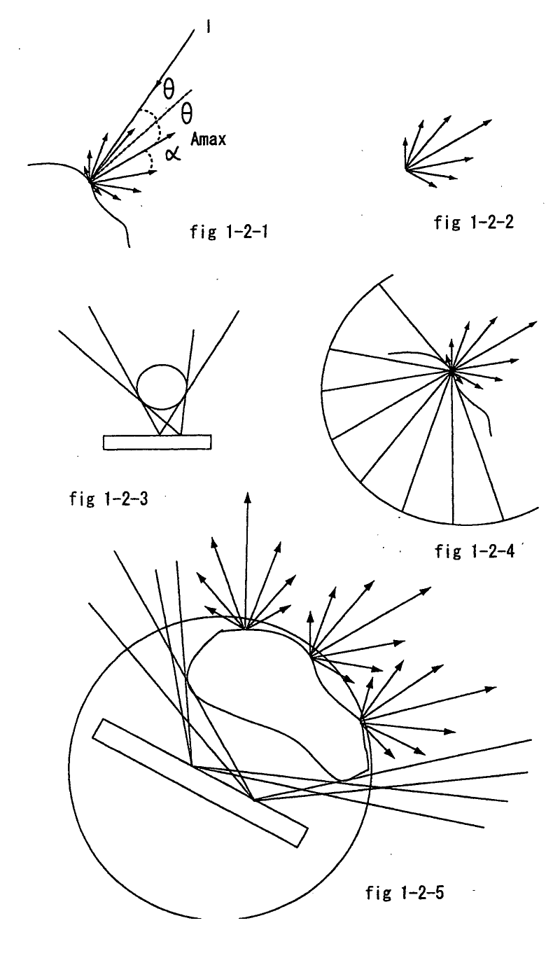

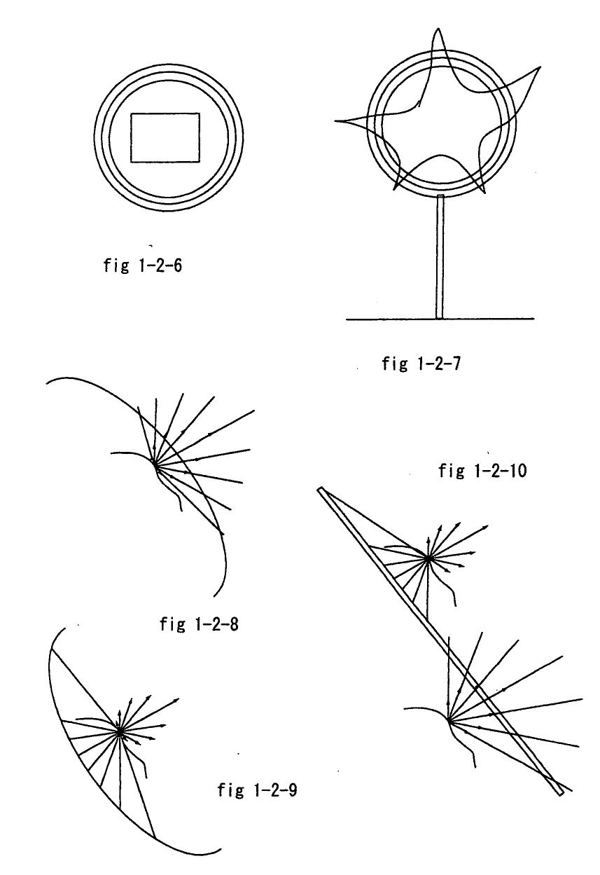

Description—FIG. 1-1-1 Preferred Embodiment

A preferred embodiment of intelligent system and the 3 dimensional Image Display inventions is illustrated in FIG. 1-1-1.

FIG. 1-1-1 shows the example diagrams of 3D display from side view. This can be made of fast response liquid crystal panels with polarizing plate (20) and light source (30). The first ferroelectric liquid crystal creates the patterns of pinholes arrays. The second liquid crystal creates the patterns with which 2D image would be converted to 3D image. By having different locations of pinholes in fast response shifting, it produces the high resolution of 3 dimensional images. The mask means can be inserted between those two panels.

Description—The Rest Alternative Embodiment

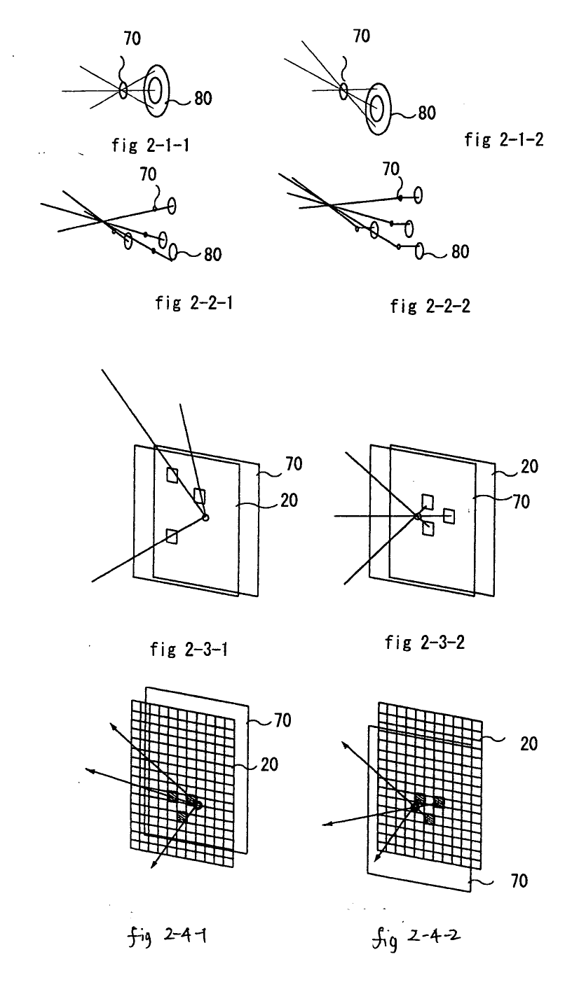

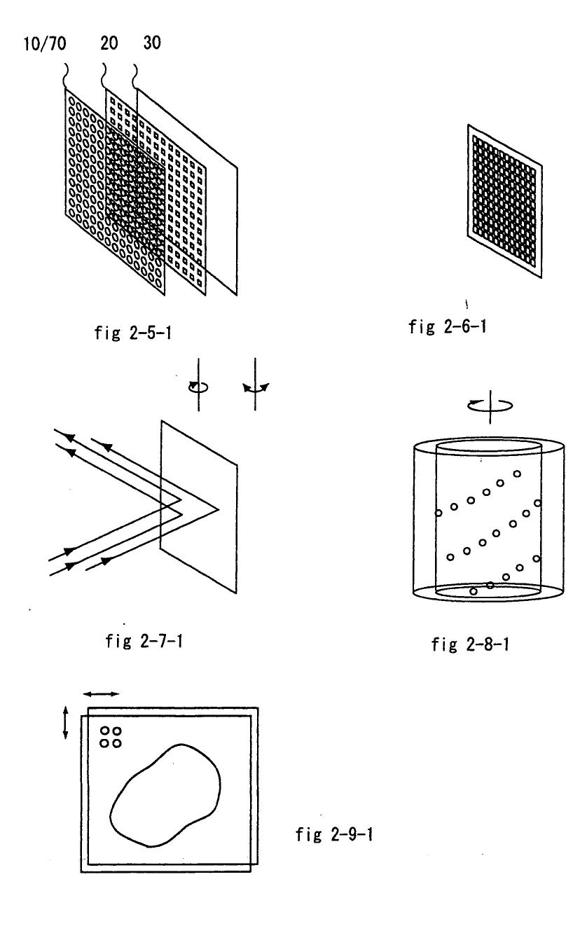

FIG. 1-1-2 shows the example diagams of 3D display from side view. By having varifocal micro-lens arrays to 2D display such as liquid crystal panel with polarizing plate (20) and light source (3), it creates the 3D image.

FIG. 1-1-3 shows the example diagrams of 3D display from side view. By having varifocal micro-lens arrays to 2D display such as organic electroluminescent luminescent display, plasma display, CRT, etc. to create 3D image.

FIG. 1-1-4 shows the example diagrams of 3D display from side view. The nano-2D pattern generator (light diffraction generator) (20) makes incoming lights (30) diffract to the directions to generate the desired light fields. The nano-2D generator can be made of nano-liquid crystals arrays. This can be color if light source changes the RGB color rapidly and controlled patterns on the diffracting plate are changed correspondingly. The eyes mix up them as true color.

FIG. 1-1-5 shows the example diagrams of 3D display from side view. The light from light source (30) enters to varifocal lens (10) and enters the micro-lens arrays (70). By changing the focus of varifocal lens rapidly, the multiplication of 2D image occurs and therefore creates 3D image.

FIG. 1-1-6 shows the example diagrams of 3D display from side view. The polarized light (30) comes into the 2D pattern generator such as liquid crystal panel (20) attached to varifocal (electro-optic) micro-lens arrays (10). The 2D patterns would be lifted up to different heights rapidly to generate 3D images.

FIG. 1-1-7 shows the example diagrams of 3D display from side view. The 2D image light (20) comes into varifocal lens such as liquid crystal index-gradient lens (10) and micro-lens arrays. The varifocal lens changes rapidly to lift 2D image different heights rapidly to generate 3D images. Varifocal liquid crystal index-gradient lens can be made of liquid crystal that can create different index of refraction based on the controlled electrical field (voltage).

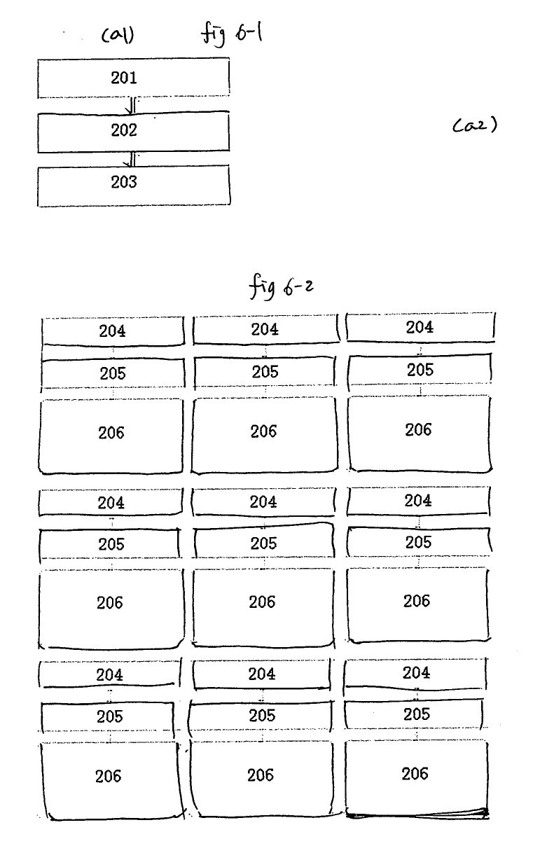

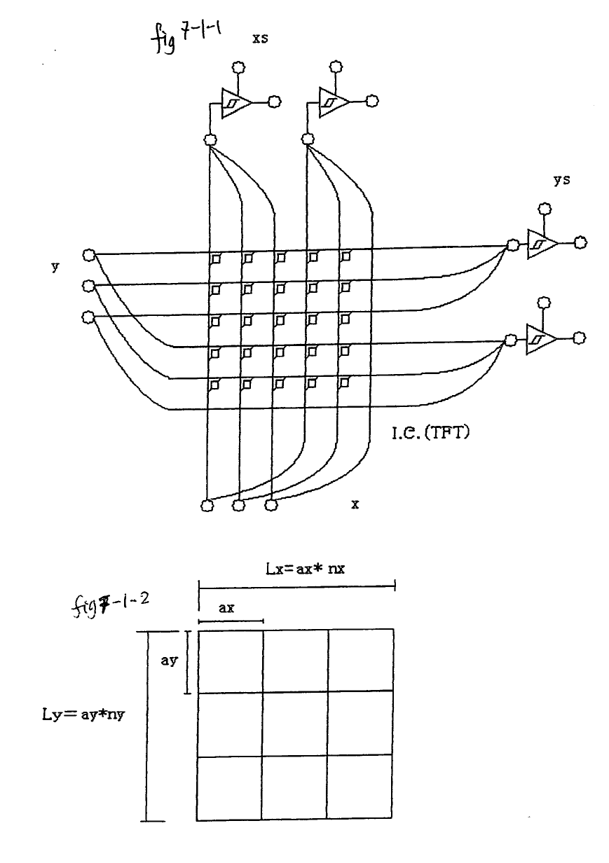

FIG. 1-1-8 shows the example diagrams of 3D display from side view. 2D image are projected from 2D display (20). Image focusing device such as varifocal lens or parallel beam generator (10/150) makes the 2D image on focus on different height of liquid crystal screen (50). The liquid crystal can be coated with anti-reflection and can be ferroelectric or nematic. By switching the liquid crystal screen rapidly, it generates 3D images. The virtual resolution with frictional color-intensity on pixels can be used as well.

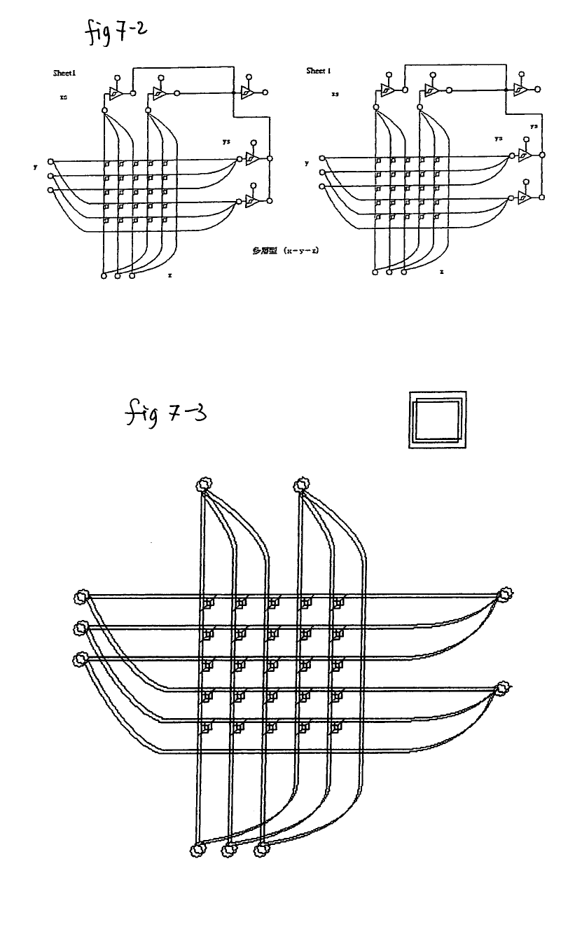

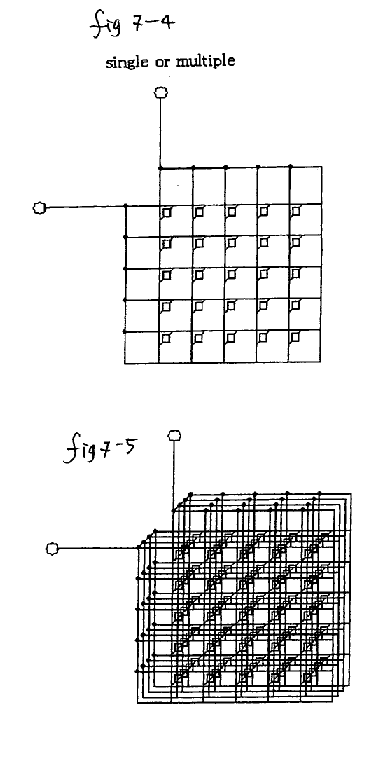

FIG. 1-1-9 shows the example diagrams of 3D display from side view. The light from uniform light source (30) is converted to parallel uniform light beam with index-gradient lens (150). The high-resolution patterns on 2D display (20) would be directed properly by micro-lens arrays (70) to make light vector fields and therefore to generated 3D images.

FIG. 1-2-1 shows the example diagrams of incoming light and reflected & scattered outgoing lights and its distribution with angles from 3D object surface.

FIG. 1-2-2 shows the example diagrams of virtual light point. The desired patterns of light vector fields to emulate the light reflection on 3D object.

FIG. 1-2-3 shows the example diagrams of multi-objects can put together. When only location of virtual light point is controlled, 3D images are see-through. By controlling the location and direction of virtual light points (field), it can have multiple objects behind each other to create realistic 3D image. Viewers don't see the surface of plate behind the sphere as realistic world is though when the viewing angle of viewers changes, the surface start showing up because it is creating virtually the real light fields created by real objects.

FIG. 1-2-4 shows the example diagrams of shapes of 3D display with hemisphere to create the virtual light fields.

FIG. 1-2-5, 1-2-6, 1-2-7 shows the example diagrams of the spherical 3D display that can show 3D image inside and outside of display. User has full view angels of 3D images.

FIG. 1-2-8, 1-2-9 shows the example diagrams of shapes of 3D display with curved surface panel to create the virtual light fields. These can be chosen based on the needs of users if they like 3D images to be inside or outside.

FIG. 1-2-10 shows the example diagrams of shapes of 3D display with flat surface plane to create the virtual light fields.

FIG. 2-1-1 shows the example diagrams of pinhole/micro-lens (70) with 2D image (80) behind to create the color-intensity and direction of virtual light. Most likely these are moved to create 3D images.

FIG. 2-1-2 shows the example diagrams of way how the direction is changed from FIG. 2-1-1.

FIG. 2-2-1 shows the example diagrams of multiple pinholes with 2D image behind to create 3D virtual light point.

FIG. 2-2-2 shows the example diagrams of multiple micro-lenses with 2D image behind to create 3D virtual light point.

FIG. 2-3-1, 2-3-2, 2-4-1, 2-4-2 shows the example diagrams of micro-lens/pinhole arrays with 2 D image behind to create 3D images.

FIG. 2-5-1 shows the example diagrams of way how the pinhole arrays, liquid crystal panel (with polarizing plate) and light source can be put together.

FIG. 2-6-1 shows the example diagrams of micro-mirror device. Each unit changes the angle in x-y direction to produce the vector fields from incoming light source and therefore 3D images.

FIG. 2-7-1 shows the example diagrams of way how to make 3D image using motion of reflector in linear and/or (full/partial) rotational movement. Input light can have 2D images already so that when it is reflected to proper angles, it generates 3D vector light fields and images.

FIG. 2-8-1 shows the example diagrams of rotational pinholes and liquid crystal outside to have higher resolution 3D image with 360 degrees of view angles.

FIG. 2-9-1 shows the example diagrams of way to shake the 3D display panel in x-y plane to have higher 3D image resolution. The 2D patterns changes rapidly according to 3D images.

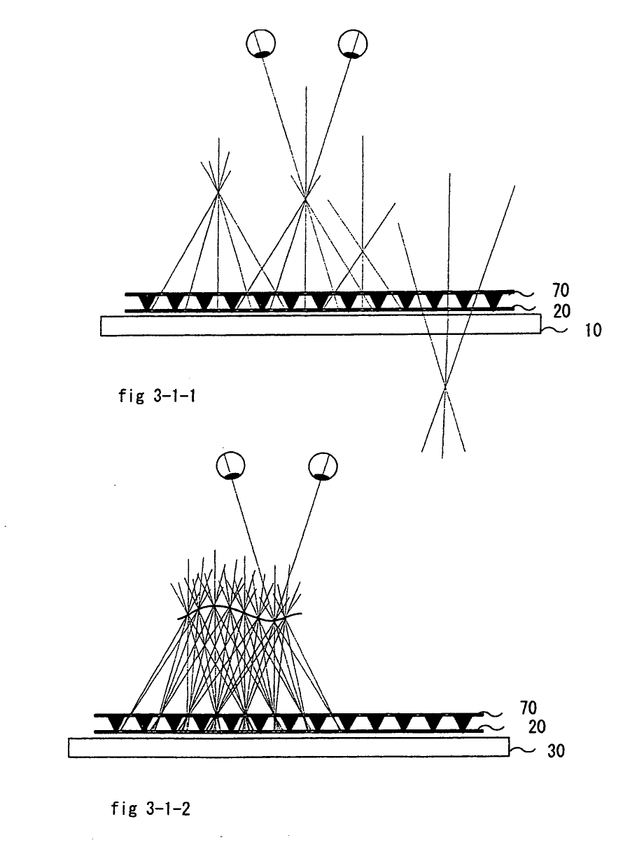

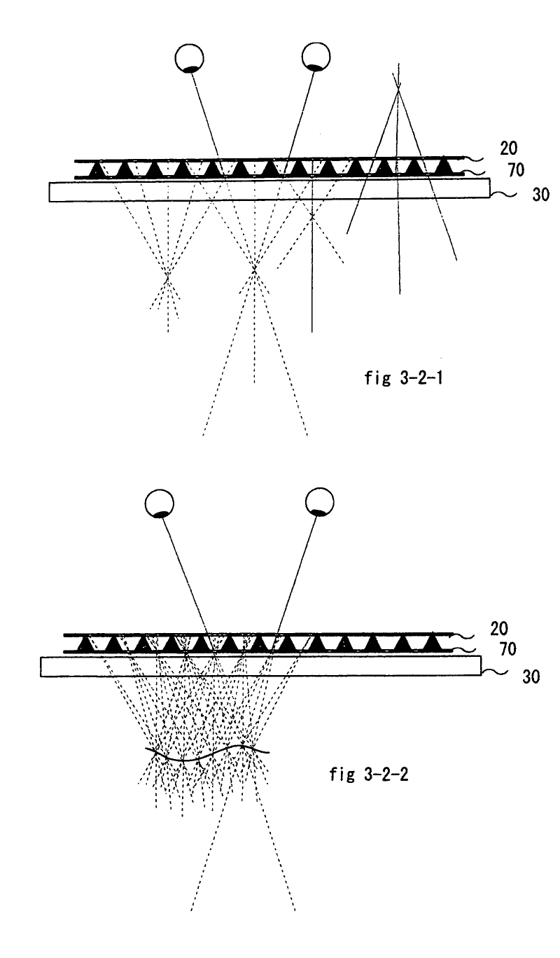

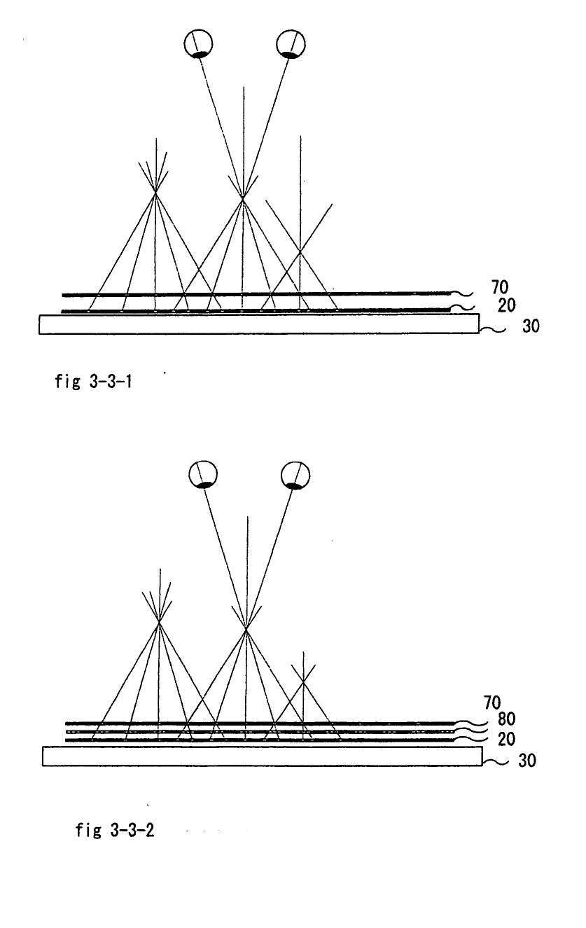

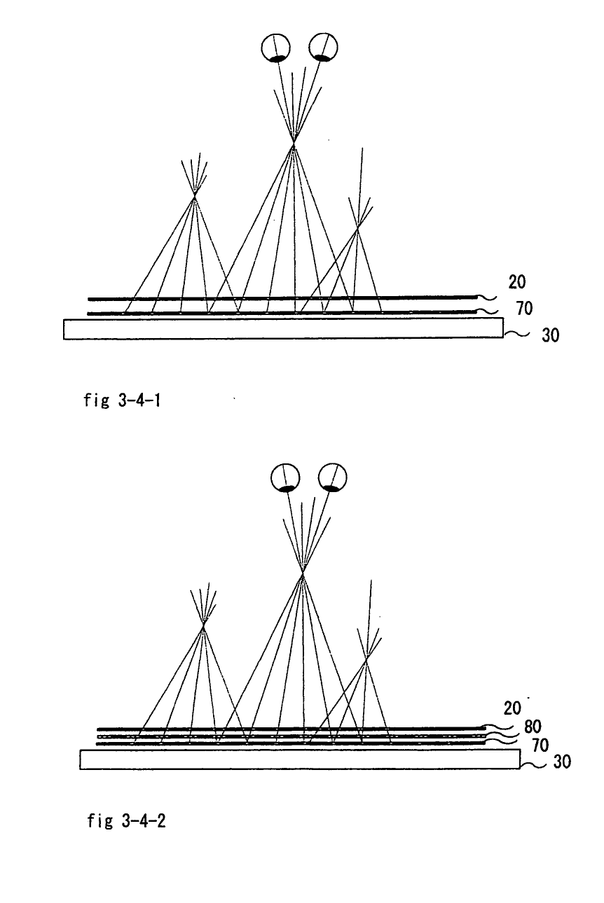

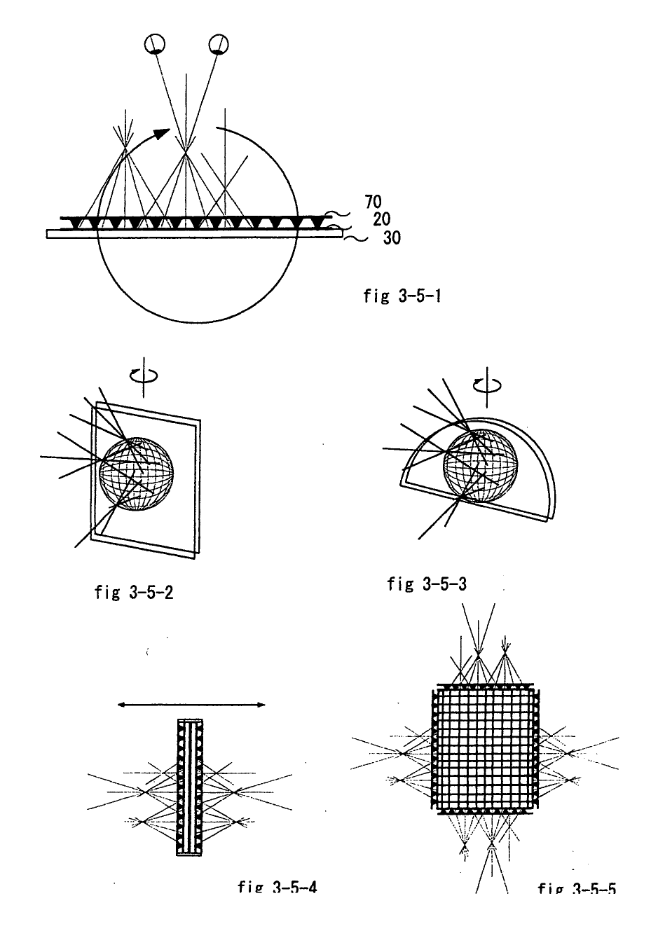

FIG. 3-1-1 shows the example diagrams of 3D display. Pinholes (70) and masks are on the top of 2D display (20). Pixels from 2D display (20) go through the corresponding pinholes (70) and are focused to virtual point(s). Position and color-intensity of each pixel on 2D display is properly controlled to produce the virtual light point(s) that has proper angle and color-intensity distribution.

FIG. 3-1-2 shows the example diagrams of 3D display with multiple virtual light points to produce the surface of 3D images.

FIG. 3-2-1, 3-2-2 shows the example diagrams of 3D display. Pinholes (70) and masks are behind the 2D display panel (20).

FIG. 3-3-1 shows the example diagrams of 3D display. Liquid crystal panel creates pinholes (70) and is on the top of 2D display (20). The positions of pinholes and patterns on 2D display change rapidly to have higher resolution 3D image.

FIG. 3-3-2 shows the example diagrams of 3D display. First liquid crystal panel creates pinholes (70). Second liquid crystal panel creates masks (80). Third liquid crystal panel makes the patterns (80). Light is projected from the behind (30). The polarizing plate is properly inserted. The positions of pinholes, masks and patterns on 2D display change rapidly to have higher resolution 3D image. This has advantage in having 1 to 1 correspond relationship. In other words, viewers don't see the extra dots when view angle is widened.

FIG. 3-4-1 shows the alternative example diagrams of 3D display. Liquid crystal panel creates pinholes (70) and is behind 2D display (20). The positions of pinholes and patterns on 2D display change rapidly to have higher resolution 3D image.

FIG. 3-4-2 shows the alternative example diagrams of 3D display. First liquid crystal panel creates patterns (20). Second liquid crystal panel creates masks (80). Third liquid crystal panel creates pinholes (70). Light is projected from the behind (30). The polarizing plate is properly inserted. The positions of pinholes, masks and patterns on 2D display change rapidly to have higher resolution 3D image. This has advantage in having 1 to 1 correspond relationship. In other words, viewers don't see the extra dots when view angle is widened.

FIG. 3-5-1 through 3-5-4 shows the example diagrams of 3D display. By rotating and/or reciprocating the 3D display panel rapidly with proper calculation, viewer would have wider view angles of 3D images.

FIG. 3-5-1 shows the example diagrams of 3D display. It is surrounded by 3D display-panels. This can be moved as well.

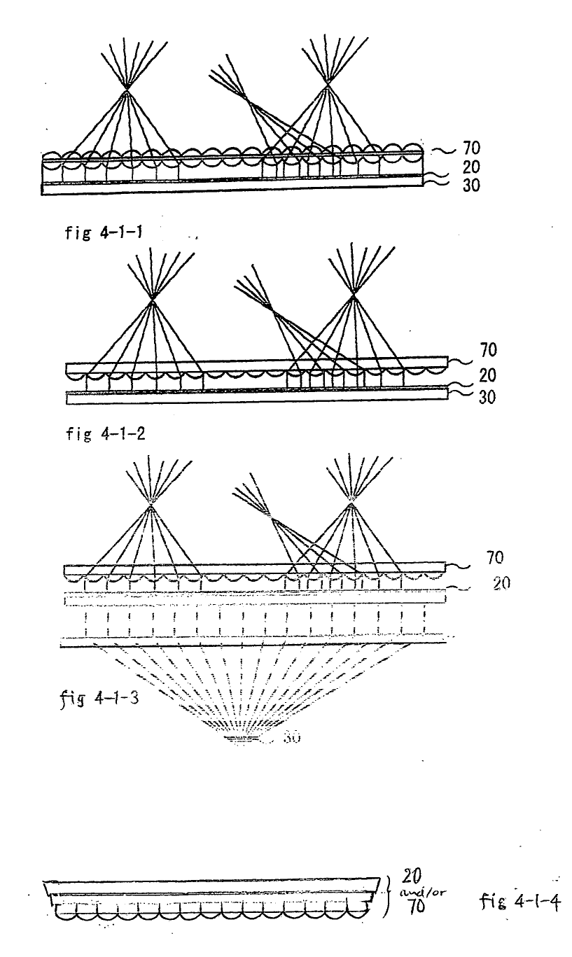

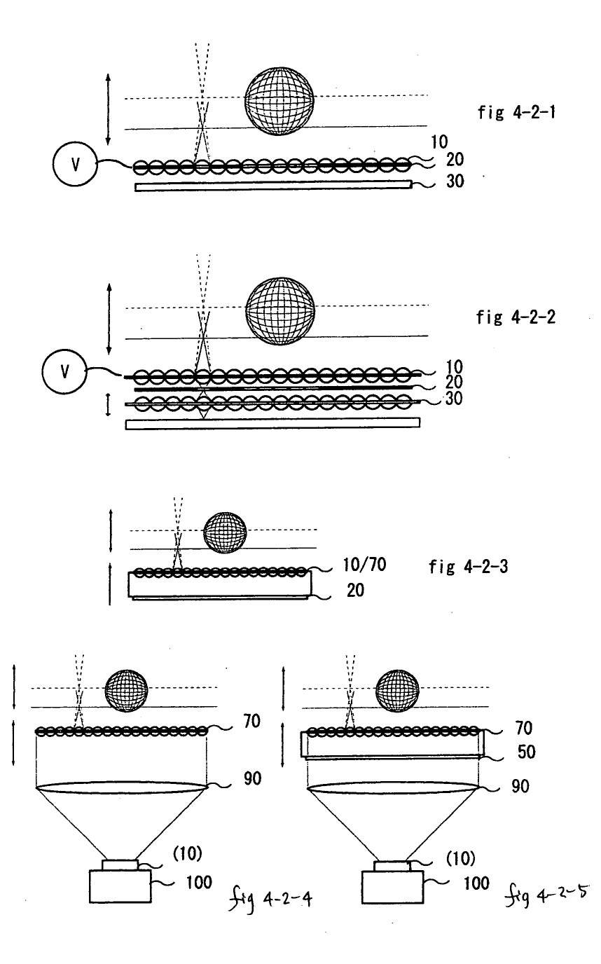

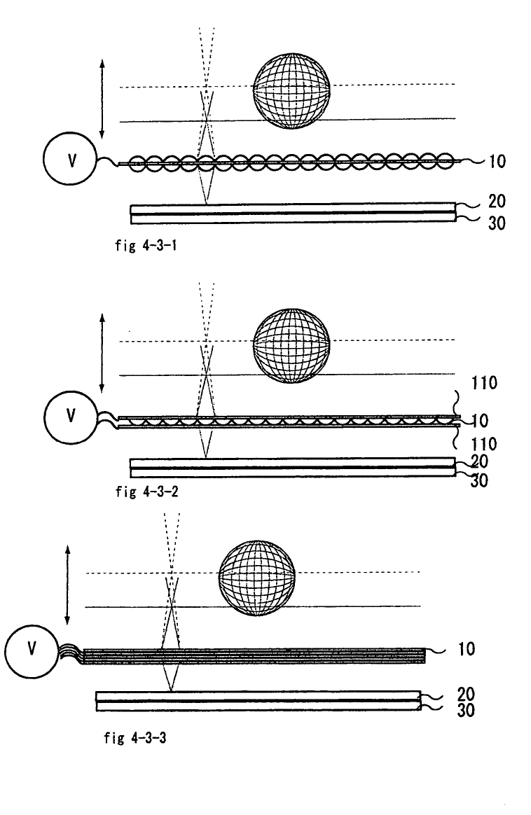

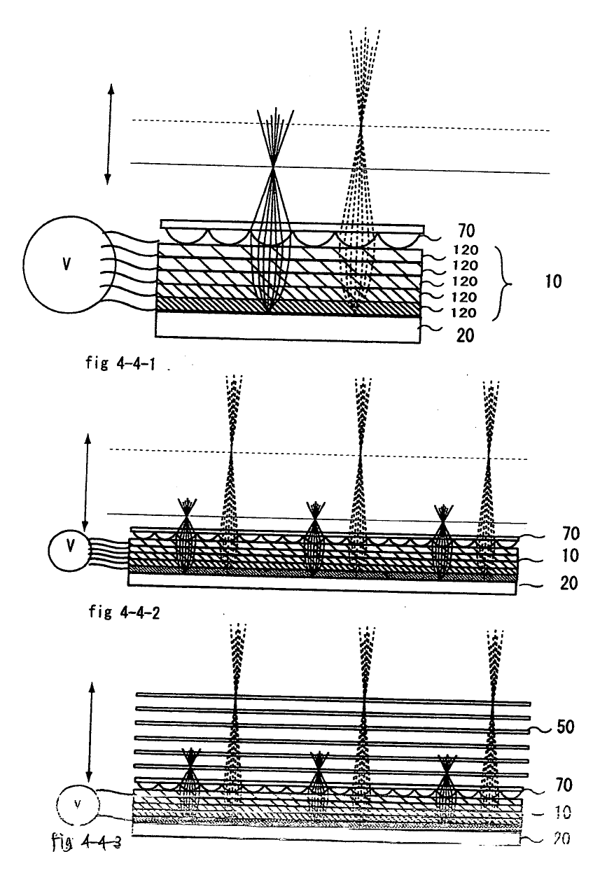

FIG. 4-1-1, 4-1-2 shows the example diagrams of 3D display. Parallel light beams are generated by light source (30). Proper locations of pixels are open on 2D display such as liquid crystal panel (20) and lights go through those open positions and directed properly when they go through the micro-lens arrays (70) to create light vector field and 3D images.

FIG. 4-1-3 shows the example diagrams of 3D display. Parallel beam is generated by optical instrument such as lens or light fiber.

FIG. 4-1-4 shows the example diagrams of 3D display. The light source can be uniform field.

FIG. 4-2-1 shows the example diagrams of 3D display. Index-of-refraction-changing-materials is used to make varifocal lens. Varifocal lens (10) such as electro-optic micro-lens shape is put on liquid crystal (20). 2D image is projected to air, and by changing the heights of the projected 2D images created by 2D liquid crystal display and varifocal lens, it generated 3D images. Varifocal lens and liquid crystal can be separated properly.

FIG. 4-2-2 shows the example diagrams of 3D display. Micro-array lens can be moved rapidly to adjust the height of 2D images created by 2D display (20) to produce 3D images.

FIG. 4-2-3, 4-3-1 and 4-3-2 shows the example diagrams of 3D display. Varifocal micro-lens arrays (10) are put over 2D display (20). It lifts 2D images in the air. By changing the focal length by varifocal lens, it can create 3D images.

FIG. 4-2-4, 4-2-5 shows the example diagrams of 3D display. 2D light patterns are projected to reciprocating micro-lens arrays/pinhole lens arrays to produce the floating 3D images. High-speed 2D image projector and optional varifocal lens can be used.

FIG. 4-3-3 shows the example diagrams of 3D display. By having varifocal liquid crystal lens, varifocal index-gradient lens or varifocal liquid crystal lens, it creates 3D images.

FIG. 4-4-1, 4-4-2 shows the example diagrams of 3D display. By having micro-lens arrays and varifocal liquid crystal lens, varifocal index-gradient lens or varifocal liquid crystal lens, it creates 3D images. Index-gradient lens is the lens that has gradient (small) changes in index of refraction according to the depth in the lens so that incoming light changes the directions according to the distribution of index of refraction in the lens. Varifocal index-gradient lens are layers of materials (like liquid crystals) whose index of refraction can be controlled. For example, by putting together liquid crystals that changes the index of refraction by voltage, it becomes a varifocal (focus changeable) index-gradient lens. The liquid crystals can have different index of refraction from the beginning having a same or different voltage to each layer. It also can be the same index of refraction liquid crystal material by having different voltage to each.

FIG. 4-4-3 shows the example diagrams of 3D display. By adding the liquid crystal screens to FIG. 4-4-2, the 2D image shows up clearly. By switching the liquid crystal fast, it produces the 3D images.

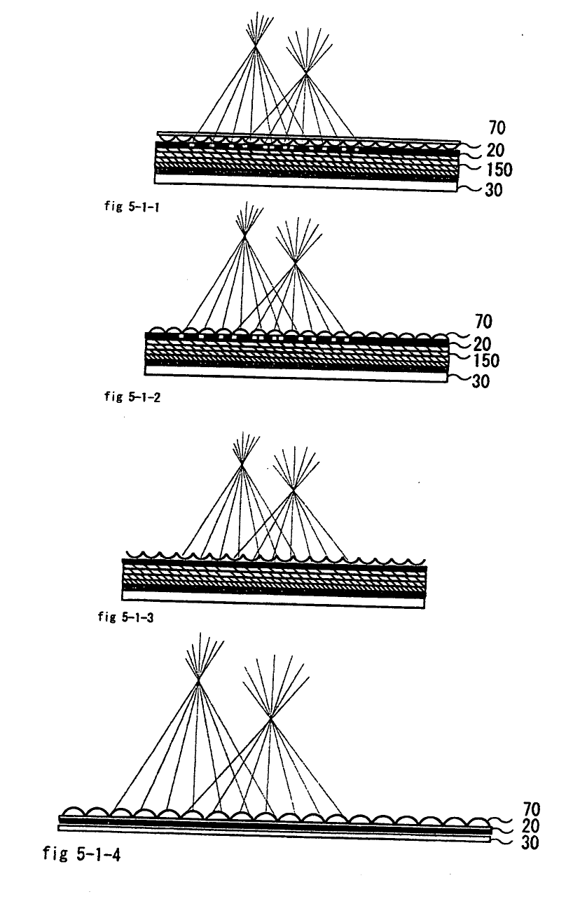

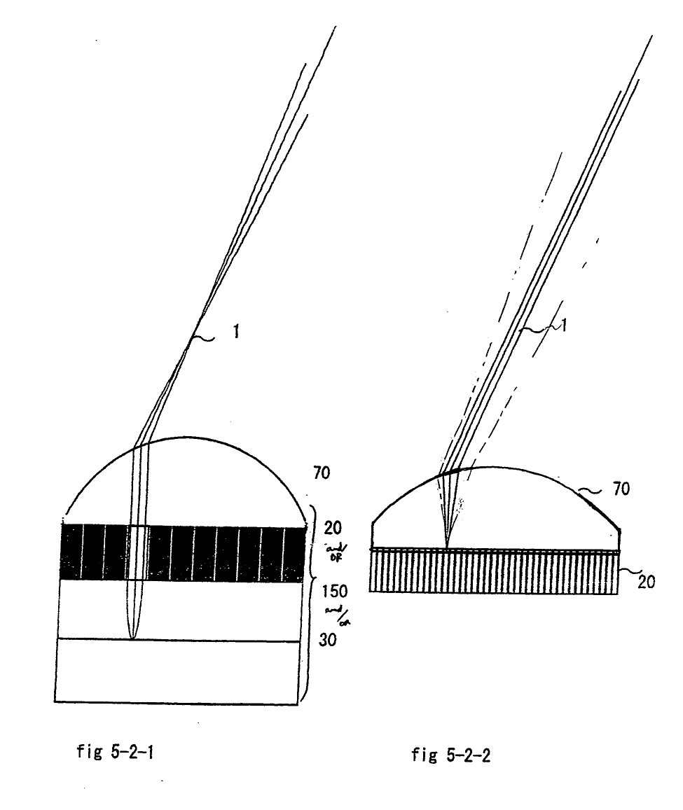

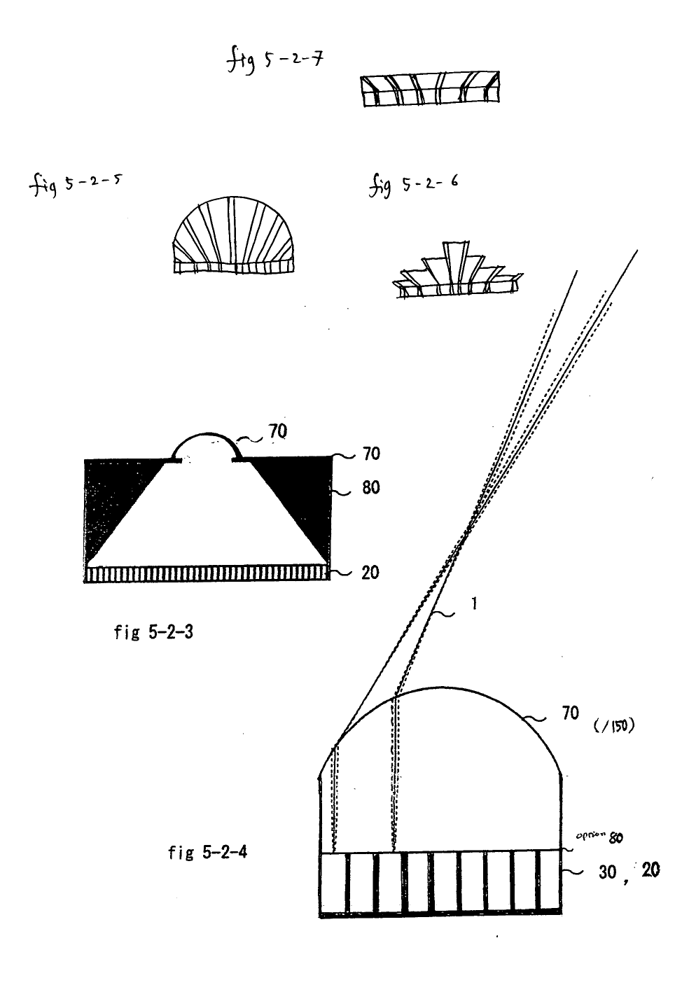

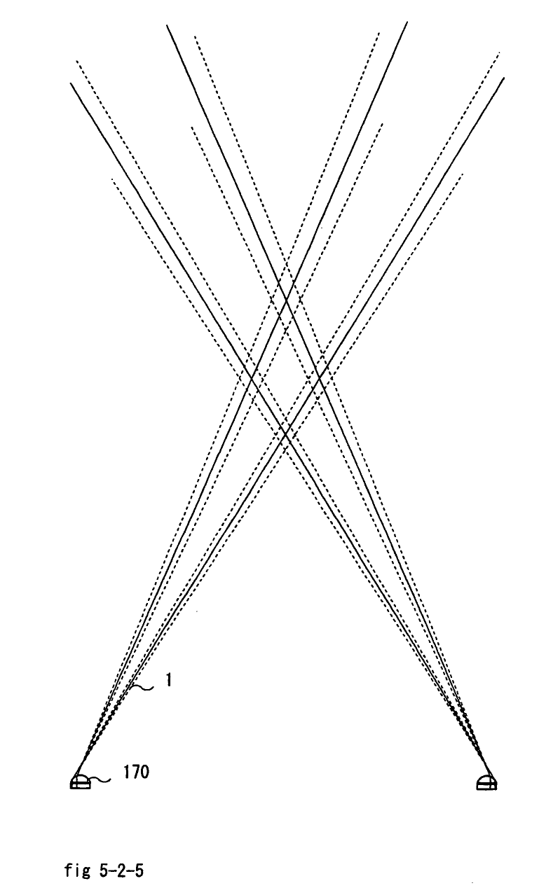

FIG. 5-1-1, 5-1-2 shows the example diagrams of 3D display. Micro-lens arrays (70), index-gradient lens (150) and liquid crystal panel (20) and (with polarizing plate) light source (30) are put together. Emitted light from light source is modified to be parallel or uniform through index-gradient lens. By selecting the light rays by having patterns in 2D display such as liquid crystal panel and by directing those selected rays, it creates the light vector fields and 3D images.

FIG. 5-1-3 shows the alternative example diagrams of 3D display of FIG. 5-1-1,5-1-2.

FIG. 5-1-4 shows the example diagrams of 3D display. Micro-lens arrays (70) and liquid crystal panel (20) and (with polarizing plate) light source (30) are put together. By calculating and selecting the light rays by having patterns in 2D display such as liquid crystal panel and by directing those selected rays, it creates the light vector fields and 3D images.

FIG. 5-2-1, 5-2-4 shows the example diagrams of elementary unit of 3D display. Micro-lens arrays (70), high-resolution 2D display (20), index-gradient lens (150) and light source (30) are shown together with the paths of light rays.

FIG. 5-2-2 shows the example diagrams of elementary unit of 3D display. Micro-lens arrays (70), high-resolution 2D display (20) such as light emitting arrays such as diode laser arrays and organic electro-luminescent display, plasma display, liquid crystal display, CRT. The purpose is to create outgoing parallel beams.

FIG. 5-2-3 shows the example diagrams of elementary unit of 3D display. Pinhole and/or lens (70), (frame) mask (80) and/or 2D display (for image(s) such as dynamic image(s) or still image) (20) is shown.

FIG. 5-2-4 shows the example diagrams of elementary unit of 3D display. Pinhole and/or lens (70), (frame) mask (80), light reflector/emitter (30) and/or 2D display/ (nano-) light-field-generator (for image(s) such as dynamic image(s) or still image) (20) is shown.

FIG. 5-2-5 shows the example diagrams of elementary units of 3D display.

FIG. 6-1 shows the example diagram of image data/information controller.

FIG. 6-2 shows the example diagram of image data/information controller.

FIG. 7-1-1 shows the example diagram of sectional TFT concept.

FIG. 7-1-1 shows the example diagram of sectional TFT concept by units and sections.

FIG. 7-2 shows the example diagram of multi-dimensional display grid concept.

Signal number may be shown as

$$Sg = {\sum }_{μ , v} {k}_{μ v ξ} {k}_{μ v ' ξ '} ,$$

where k is unit or section and Greek letters are index.

FIG. 7-3 shows the example diagram of TFT with trans-informational method such as wireless information (/with wired electrode(s)). FIG. 6-1 and/or FIG. 6-2 may be used.

FIG. 7-4 shows the alternative example diagram of TFT with trans-informational method such as wireless information (/with wired electrode(s)). FIG. 6-1 and/or FIG. 6-2 may be used.

FIG. 7-5 shows the alternative example diagram of multiple layers of TFT with trans-informational method such as wireless information (/with wired electrode(s)). FIG. 6-1 and/or FIG. 6-2 may be used

Division A:

1. The device that displays color 3 dimensional image(s) in the space in real time using light virtual fields creating device means.

2. The device of claim 1 wherein said light virtual fields creating device means is composed of group comprising
(1) Light rays directing device means
(2) Light rays selecting device means
(3) Optionally, Light source means
(4) Optionally, mask means
(5) Optionally, optical instruments means

3. The device of claim 2 wherein said light rays directing device means is composed of group comprising
pinhole arrays, micro-lens arrays, micro-mirror arrays, liquid crystal pinhole arrays, varifocal pinhole lens, varifocal micro-lens array, varifocal liquid crystal lens, varifocal liquid crystal micro-lens, varifocal vertical liquid crystal lens, varifocal holizontalc liquid crystal lens, varifocal liquid crystal fresnel lens, micro-reflector, varifocal micro-piezoelectric reflector, varifocal piezoelectric micro-lens, adaptive optical lens, adaptive optical micro-lens

4. The device of claim 2 wherein said light rays selecting device means is composed of group comprising
liquid crystal display, liquid crystal panels, liquid crystal panel with polarizing plate, micro-liquid crystal arrays, organic electro-luminescent display, inorganic electroluminescent display, plasma display, laser arrays, diode laser arrays, electrodes, clear electro-conductive sheet, liquid crystal display with continuous grain silicon

5. The device of claim 2 wherein said light source means is composed of group comprising
light source, uniform light source, non-uniform light source diode light emitting plate, arc lamp, halogen light, electron beam emitter, light bulb

6. The device of claim 2 wherein said mask means is composed of group comprising
masks, hole masks, liquid crystal masks, liquid crystal with continuous grain silicon

7. The device of claim 2 wherein said optical instruments means is composed of group comprising
lens, micro-lens, index-gradient lens, pinhole lens, varifocal lens, liquid crystal varifocal lens, varifocal index-gradient lens, varifocal liquid crystal varifocal lens, prisms, mirrors, curved mirrors, half-mirrors, color filters, polarizing plate

8. The device of claim 1 wherein said light virtual fields creating device means is composed of group comprising
(1) Three dimensional image display units with flat or curved surface means
(2) Optionally, motion generating device means

9. The device of claim 8 wherein said Three dimensional image display units with flat or curved surface means is composed of group comprising
(1) pinhole arrays, micro-lens arrays, micro-mirror arrays, liquid crystal pinhole arrays, varifocal micro-lens array liquid crystal display, liquid crystal panels, liquid crystal panel with polarizing plate, micro-liquid crystal arrays, organic electro-luminescent display, inorganic electro-luminascient display, plasma display, laser arrays, diode laser arrays, liquid crystal with continuous grain silicon
(2) Optionally, Light source means
(3) Optionally, mask means
(4) Optionally, optical instruments means

10. The device of claim 8 wherein said motion generating means is composed of the group consisting of group comprising
linear stage, rotational stage, motors, linear motors, gears, bearing, magnetic oscillator, electromagnetic motion generator, ultrasound motor

11. The device that changes the focal length of lens using varifocal lens means

12. The device of claim 11 wherein said varifocal lens means is composed of group comprising
varifocal index-gradient lens means
comprising layers of materials that changes index of refractions such as varifocal liquid crystal index-gradient lens
comprising layers of liquid crystals that changes index of refractions by voltages driven by drivers

13. The device of claim 11 wherein said varifocal lens means is composed of group comprising
varifocal index-gradient lens means
comprising varifocal acousto-optic index-gradient lens
comprising layers of optic-optic materials crystals that changes direction of lights

14. The device of claim 11 wherein said varifocal lens means is composed of group comprising
varifocal pinhole lens
comprising liquid crystal pinhole or liquid crystal pinhole arrays whose diameters change by the pattern created by liquid crystal panels with polarizing plate

15. The device of claim 11 wherein said varifocal lens means is composed of group comprising
varifocal micro-lens arrays
comprising electro-optic material micro-lenses such as liquid crystal micro-lens array

16. The device of claim 11 wherein said varifocal lens means is composed of group comprising
varifocal motion micro-lens arrays
comprising group comprising micro-lenses and the motion generating device such as motors, magnetic motion generator, reciprocating motion generator, ultrasound motion generator
Division B:

1. The device that has micro-arrays of light emitter means

2. The device of claim 1 wherein said micro-arrays of light emitter means is composed of group comprising
(1) micro-lasers, micro diode lasers, photo-luminescent chemical components
(2) base means comprising silicon, glass, plastic
(3) drivers

3. The device of claim 1 wherein said micro-arrays of light emitter means is composed of group comprising
ferroelectric liquid crystal on uniform photo-luminescent chemical material, continuous grain silicon liquid crystal on uniform photo-luminescent chemical material

4. The device of claim 1 wherein said micro-arrays of light emitter means is composed of group comprising
liquid crystal on uniform photo-luminescent chemical material with micro-lens arrays,
ferroelectric liquid crystal on uniform photo-luminescent chemical material with micro-lens arrays,
continuous grain silicon liquid crystal arrays on uniform photo-luminescent chemical material with micro-lens arrays
